(19) United States
(12) Patent Application Publication
(10) Pub. No.: US 2024/0266608 A1
(43) Pub. Date: Aug. 8, 2024

(54) LITHIUM SECONDARY BATTERY

(71) Applicant: TeraWatt Technology K.K., Yokohama-shi (JP)

(72) Inventors: Gosuke Oyama, Yokohama-shi (JP); Hiroshi Imoto, Yokohama-shi (JP)

(73) Assignee: TeraWatt Technology K.K., Yokohama-shi (JP)

(21) Appl. No.: 18/601,657

(22) Filed: Mar. 11, 2024

Related U.S. Application Data
(63) Continuation of application No. PCT/JP2021/033741, filed on Sep. 14, 2021.

(51) Int. Cl. H01M 10/0569; H01M 10/0525; H01M 10/0568

(52) U.S. Cl. CPC H01M 10/0569; H01M 10/0525; H01M 10/0568; H01M 2300/0034; H01M 2300/004

(57) ABSTRACT

The purpose of the present invention is to provide a lithium secondary battery in which a high energy density, an excellent cycle characteristic, and a high stability against changes in environmental temperature are achieved. The present invention relates to a lithium secondary battery including a positive electrode, a negative electrode not having a negative-electrode active material, and an electrolyte solution, in which the electrolyte solution contains, as a solvent, an ether not having a fluorine atom, a hydrofluoroether, and a saturated or unsaturated chain hydrofluorocarbon.

### CROSS-REFERENCE TO RELATED APPLICATION

This application is a continuation of International Patent Application No. PCT/JP2021/033741, entitled “Lithium Secondary Battery”, filed Sep. 14, 2021, the entire contents of which are incorporated by reference.

### BACKGROUND

### Field

The present invention relates to a lithium secondary battery.

### Description of Related Art

The technology of converting natural energy such as solar light and wind power into electric energy has recently attracted attentions. Under such a situation, various secondary batteries have been developed as a highly-safe power storage device capable of storing a lot of electric energy.

Among them, lithium secondary batteries which perform charge/discharge by transferring lithium ions between a positive electrode and a negative electrode are known to exhibit a high voltage and a high energy density. As typical lithium secondary batteries, lithium-ion secondary batteries (LIB) which have a positive electrode and a negative electrode having an active material capable of retaining lithium element and perform charge/discharge by delivering or receiving lithium ions between a positive-electrode active material and a negative-electrode active material are known.

For the purpose of realizing high energy density, a lithium secondary battery (lithium metal battery; LMB) that lithium metal is used as the negative-electrode active material, instead of a material into which the lithium ion can be inserted, such as a carbon material, has been developed. For example, PCT Japanese Translation Patent Publication No. 2006-500755 discloses a rechargeable battery using, as a negative electrode, an electrode based on lithium metal.

For the purpose of further improving high energy density and improving productivity, or the like, a lithium secondary battery using a negative electrode that does not have a negative-electrode active material such as the carbon material and the lithium metal has been developed.

For example, PCT Japanese Translation Patent Publication No. 2019-505971 discloses a lithium secondary battery including a positive electrode and a negative electrode, and a separation membrane and an electrolyte interposed therebetween. In the aforesaid negative electrode, metal particles are formed on a negative electrode current collector and transferred from the positive electrode, when the battery is charged, to form lithium metal on the negative electrode current collector in the negative electrode. PCT Japanese Translation Patent Publication No. 2019-505971 discloses that such a lithium secondary battery shows the possibility of providing a lithium secondary battery which has overcome the problem due to the reactivity of the lithium metal and the problem caused during assembly process and therefore has improved performance and service life.

### SUMMARY

When the present inventors studied batteries of the prior art including those described in the PCT Japanese Translation Patent Publication No. 2006-500755 and PCT Japanese Translation Patent Publication No. 2019-505971 mentioned above, they found that at least one of energy density, cycle characteristics, or stability against changes in environmental temperature is insufficient.

For example, in the lithium secondary battery that includes a negative electrode containing the negative-electrode active material, due to the volume or mass occupied by the negative-electrode active material, it is difficult to sufficiently increase the energy density. In addition, even in conventional anode-free lithium secondary batteries that includes a negative electrode not having a negative-electrode active material, due to repeated charge/discharge, a dendrite-like lithium metal is likely to be formed on a surface of the negative electrode, which is likely to cause short circuiting and/or a decrease in capacity, resulting in insufficient cycle characteristic.

In the lithium secondary batteries as disclosed in the PCT Japanese Translation Patent Publication No. 2006-500755 and PCT Japanese Translation Patent Publication No. 2019-505971 mentioned above, a solvent used for the purpose of improving cycle characteristic and/or energy density typically tend to have a low boiling point and a high vapor pressure. The present inventors have found that, in the lithium secondary batteries as disclosed in PCT Japanese Translation Patent Publication No. 2006-500755 and PCT Japanese Translation Patent Publication No. 2019-505971, in a case where the composition of the electrolyte solution is adjusted in order to improve the cycle characteristic and/or the energy density, the composition of the electrolyte solution is likely to be changed in a case where the electrolyte solution is exposed to a high temperature, and the stability against changes in environmental temperature is reduced.

The present invention has been made in consideration of the aforesaid problems and a purpose is to provide a lithium secondary battery in which a high energy density, an excellent cycle characteristic, and a high stability against changes in environmental temperature are achieved.

A lithium secondary battery according to one embodiment of the present invention includes a positive electrode, a negative electrode not having a negative-electrode active material, and an electrolyte solution, in which the electrolyte solution contains, as a solvent, an ether not having a fluorine atom, a hydrofluoroether, and a saturated or unsaturated chain hydrofluorocarbon.

In the lithium secondary battery according to the above-described embodiment, since the negative electrode not having a negative-electrode active material is used, the volume and mass of the entire battery are smaller and the energy density is higher in principle as compared with a lithium secondary battery having a negative-electrode active material. In the lithium secondary battery according to the above-described embodiment, a lithium metal is deposited on a surface of the negative electrode, and charge/discharge are performed by electrolytically dissolving the deposited lithium metal.

In addition, the present inventors have found that, in a case where the electrolyte solution containing, as a solvent, an ether not having a fluorine atom, a hydrofluoroether, and a saturated or unsaturated chain hydrofluorocarbon is used, a lithium secondary battery including a negative electrode not having a negative-electrode active material can achieve a high energy density, an excellent cycle characteristic, and a high stability against changes in environmental temperature. The factor is not clear, but it is presumed that each component of the aforesaid solvent improves the energy density, the cycle characteristic, and the stability against changes in environmental temperature in a synergistic manner.

In the lithium secondary battery according to one embodiment of the present invention, it is preferable that a molecular weight of the hydrofluorocarbon is 300 or more and 600 or less. In such a mode, the lithium secondary battery tends to have even more excellent stability against changes in environmental temperature.

In the lithium secondary battery according to one embodiment of the present invention, it is preferable that a boiling point of the electrolyte solution is 74° C. or higher. In such a mode, the lithium secondary battery has even more excellent stability against changes in environmental temperature, particularly against a high temperature.

In the lithium secondary battery according to one embodiment of the present invention, it is preferable that a content of the hydrofluorocarbon is 5.0% by volume or more and 50% by volume or less with respect to a total amount of the hydrofluoroether and the hydrofluorocarbon. In such a mode, the lithium secondary battery tends to have even more excellent balance between the cycle characteristic and the stability against changes in environmental temperature.

In the lithium secondary battery according to one embodiment of the present invention, it is preferable that the hydrofluoroether has a structure represented by Formula (1). In such a mode, the lithium secondary battery tends to have even more excellent cycle characteristic.

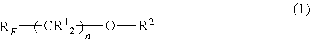

(in the formula, R_{F} is a fluorinated saturated or unsaturated monovalent hydrocarbon group, R¹ is a hydrogen atom or an alkyl group, R² is a saturated or unsaturated monovalent hydrocarbon group which may be fluorinated, and n represents an integer of 1 or more and 5 or less)

In the lithium secondary battery according to one embodiment of the present invention, it is preferable that the hydrofluoroether has at least one of a structure represented by Formula (2) or a structure represented by Formula (3). In such a mode, the lithium secondary battery tends to have even more excellent cycle characteristic.

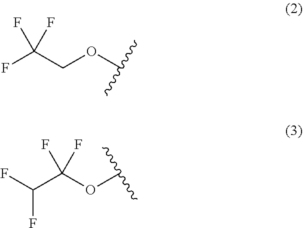 [SMILES: *OCC(F)(F)F ; *OC(F)(F)C(F)F]

In Formulae (2) and (3), a wavy line represents a bonding site in a monovalent group.

In the lithium secondary battery according to one embodiment of the present invention, it is preferable that, in the hydrofluorocarbon, a ratio (F/(F+H)) of a number (F) of fluorine atoms to a total number (F+H) of fluorine atoms and hydrogen atoms is 0.60 or more and 0.90 or less. In such a mode, the lithium secondary battery tends to have even more excellent balance between the cycle characteristic and the stability against changes in environmental temperature.

In the lithium secondary battery according to one embodiment of the present invention, it is preferable that the electrolyte solution contains LiN(SO₂F)₂ as a lithium salt. In such a mode, the lithium secondary battery tends to have even more excellent cycle characteristic.

In the lithium secondary battery according to one embodiment of the present invention, it is preferable that a total content of fluorinated solvents in the electrolyte solution is more than 50% by volume with respect to a total amount of solvent components. In such a mode, the lithium secondary battery tends to have even more excellent balance between the cycle characteristic and the stability against changes in environmental temperature.

In the lithium secondary battery according to one embodiment of the present invention, it is preferable that a content of the ether not having a fluorine atom is 3.0% by volume or more and 50% by volume or less with respect to a total amount of solvent components in the electrolyte solution. In such a mode, the lithium secondary battery tends to have even more excellent balance between the cycle characteristic and the stability against changes in environmental temperature.

According to the present invention, it is possible to provide a lithium secondary battery in which a high energy density, an excellent cycle characteristic, and a high stability against changes in environmental temperature are achieved.

### BRIEF DESCRIPTION OF DRAWINGS

FIG. 1 is a schematic cross-sectional view of a lithium secondary battery according to the embodiment of the present invention.

FIG. 2 is a schematic cross-sectional view of the use of the lithium secondary battery according to the embodiment of the present invention.

### DETAILED DESCRIPTION

The embodiment of the present invention (which will hereinafter be called “present embodiment”) will hereinafter be described in detail while referring to the drawings as needed. In the drawings, the same element will be represented by the same reference numeral and an overlapping description will be omitted. Unless otherwise specifically described, the positional relationship such as vertical or horizontal one will be based on the positional relationship shown in the drawings. The dimensional ratios shown in the drawings are not limited to the depicted ratios.

### Present Embodiment

### (Lithium Secondary Battery)

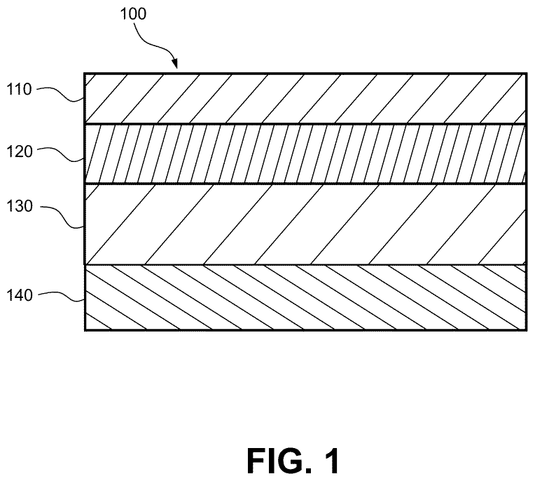

FIG. 1 is a schematic cross-sectional view of the lithium secondary battery according to the present embodiment. As shown in FIG. 1, a lithium secondary battery 100 according to the present embodiment includes a positive electrode 120, a negative electrode 140 not having a negative-electrode active material, a separator 130 placed between the positive electrode 120 and the negative electrode 140, and an electrolyte solution that is not shown in FIG. 1. The positive electrode 120 has a positive electrode current collector 110 on the surface thereof opposite to the surface facing the separator 130.

Hereinafter, each configuration of the lithium secondary battery 100 will be described.

### (Negative Electrode)

The negative electrode 140 does not have a negative-electrode active material. The “negative-electrode active material” as used herein is a substance that causes an electrode reaction, that is, an oxidation reaction and a reduction reaction at the negative electrode. Specifically, examples of the negative-electrode active material in the present embodiment include lithium metal and a host material for a lithium element (lithium ions or lithium metal). The host material for the lithium element means a material provided to retain the lithium ions or the lithium metal in the negative electrode. Such a retaining mechanism is not particularly limited, and examples thereof include intercalation, alloying, and occlusion of metal clusters. Intercalation is typically used.

In the lithium secondary battery according to the present embodiment, because the negative electrode does not have a negative-electrode active material before initial charge of the battery, charge/discharge are performed by depositing lithium metal on the negative electrode and electrolytically dissolving the deposited lithium metal. Therefore, in the lithium secondary battery according to the present embodiment, an occupation volume of the negative-electrode active material and a mass of the negative-electrode active material decreases as compared with a lithium secondary battery containing the negative-electrode active material, and the volume and mass of the entire battery are small, so that the energy density is high in principle.

In the lithium secondary battery 100 according to the present embodiment, the negative electrode 140 does not have a negative-electrode active material before initial charge of the battery, a lithium metal is deposited on the negative electrode when the battery is charged, and the deposited lithium metal is electrolytically dissolved when the battery is discharged. Therefore, in the lithium secondary battery according to the present embodiment, the negative electrode acts as a negative electrode current collector.

In a case where the lithium secondary battery 100 according to the present embodiment is compared with a lithium ion battery (LIB) and a lithium metal battery (LMB), the following points are different.

In the lithium ion battery (LIB), a negative electrode has a host material for a lithium element (lithium ions or lithium metal), this material is filled with the lithium element when the battery is charged, and the host material releases the lithium element, thereby discharging the battery. The LIB is different from the lithium secondary battery 100 according to the present embodiment in that the negative electrode has the host material for the lithium element.

The lithium metal battery (LMB) is produced by using, as a negative electrode, an electrode having lithium metal on its surface or a single lithium metal. That is, the LMB is different from the lithium secondary battery 100 according to the present embodiment in that the negative electrode has the lithium metal, that is the negative-electrode active material, immediately after assembling the battery, that is, before initial charge of the battery. The LMB uses the electrode containing lithium metal having high flammability and reactivity in its production. However, because the lithium secondary battery 100 according to the present embodiment uses the negative electrode not having lithium metal, the lithium secondary battery 100 according to the present embodiment is more safe and productive.

The negative electrode “not having a negative-electrode active material” as used herein means the negative electrode 140 does not have the negative-electrode active material or does not substantially have the negative-electrode active material. The fact that the negative electrode 140 does not substantially have the negative-electrode active material means the content of the negative-electrode active material in the negative electrode 140 is 10% by mass or less based on the total amount of the negative electrode. The content of the negative-electrode active material in the negative electrode is preferably 5.0% by mass or less and it may be 1.0% by mass or less, 0.1% by mass or less, or 0.0% by mass or less, each based on the total amount of the negative electrode 140. Since the negative electrode 140 does not have the negative-electrode active material or the content of the negative-electrode active material in the negative electrode 140 falls within the aforesaid range, the energy density of the lithium secondary battery 100 is high.

The “before initial charge” of the battery as used herein means a state from the time when the battery is assembled to the time when the battery is first charged. In addition, “at the end of discharge” of the battery means a state in which the battery voltage is 1.0 V or more and 3.8 V or less, preferably 1.0 V or more and 3.0 V or less.

The “lithium secondary battery including a negative electrode not having a negative-electrode active material” as used herein means the negative electrode 140 does not have the negative-electrode active material before initial charge of the battery. Therefore, the phrase “negative electrode not having a negative-electrode active material” may be replaced by “negative electrode not having a negative-electrode active material before initial charge of the battery”, “negative electrode that does not have a negative-electrode active material other than lithium metal regardless of the state of charging of the battery and does not have the lithium metal before initial charge”, “negative electrode current collector not having lithium metal before initial charge”, or the like. In addition, the “lithium secondary battery including a negative electrode not having a negative-electrode active material” may be replaced by an anode-free lithium battery, a zero-anode lithium battery, or an anode-less lithium battery.

In the negative electrode 140 according to the present embodiment, regardless of the state of charging of the battery, the content of the negative-electrode active material other than lithium metal may be 10% by mass or less based on the total amount of the negative electrode, preferably 5.0% by mass or less, and may be 1.0% by mass or less, 0.1% by mass or less, 0.0% by mass or less, or 0% by mass.

In addition, in the negative electrode 140 according to the present embodiment, the content of lithium metal before initial charge may be 10% by mass or less based on the total amount of the negative electrode, preferably 5.0% by mass or less, and may be 1.0% by mass or less, 0.1% by mass or less, 0.0% by mass or less, or 0% by mass.

In the lithium secondary battery 100 according to the present embodiment, in a case where the battery voltage is 1.0 V or more and 3.5 V or less, the content of lithium metal may be 10% by mass or less based on the total amount of the negative electrode 140 (preferably 5.0% by mass or less, and may be 1.0% by mass or less); in a case where the battery voltage is 1.0 V or more and 3.0 V or less, the content of lithium metal may be 10% by mass or less based on the total amount of the negative electrode 140 (preferably 5.0% by mass or less, and may be 1.0% by mass or less); or in a case where the battery voltage is 1.0 V or more and 2.5 V or less, the content of lithium metal may be 10% by mass or less based on the total amount of the negative electrode 140 (preferably 5.0% by mass or less, and may be 1.0% by mass or less).

In the lithium secondary battery 100 according to the present embodiment, a ratio M_{3.0}/M_{4.2} of a mass M_{3.0} of lithium metal deposited on the negative electrode in a state in which the battery voltage is 3.0 V to a mass M_{4.2} of lithium metal deposited on the negative electrode in a state in which the battery voltage is 4.2 V is preferably 40% or less, more preferably 38% or less, and still more preferably 35% or less. The ratio M_{3.0}/M_{4.2} may be 1.0% or more, 2.0% or more, 3.0% or more, or 4.0% or more.

Examples of the negative-electrode active material according to the present embodiment include lithium metal, alloys containing lithium metal, carbon-based materials, metal oxides, metals alloyed with lithium, and alloys containing the metals. The carbon-based material is not particularly limited, and examples thereof include graphene, graphite, hard carbon, mesoporous carbon, carbon nanotube, and carbon nanohorn. The metal oxide is not particularly limited, and examples thereof include titanium oxide-based compounds, tin oxide-based compounds, and cobalt oxide-based compounds. Examples of the aforesaid metals alloyed with lithium include silicon, germanium, tin, lead, aluminum, and gallium.

The negative electrode 140 according to the present embodiment is not particularly limited insofar as it does not have a negative-electrode active material and can be used as a current collector. Examples thereof include at least one selected from the group consisting of metals such as Cu, Ni, Ti, Fe, and other metals that do not react with Li, alloys of these metals, and stainless steel (SUS), and preferred examples thereof include at least one selected from the group consisting of Cu, Ni, alloys of these metals, and stainless steel (SUS). When this negative electrode is used, the energy density and the productivity of the battery tend to be improved further. When a SUS is used as the negative electrode, a variety of conventionally known SUSs can be used as its kind. One or more of the negative electrode materials may be used alone or in combination. The term “metal that does not react with Li” as used herein means a metal which does not form an alloy under the operation conditions of the lithium secondary battery, reacting with a lithium ion or a lithium metal.

The capacity of the negative electrode 140 is sufficiently small relative to the capacity of the positive electrode 120 and it may be, for example, 20% or less, 15% or less, 10% or less, or 5% or less. Each capacity of the positive electrode 120 and the negative electrode 140 can be measured by a conventionally known method.

The average thickness of the negative electrode 140 is preferably 4 μm or more and 20 μm or less, more preferably 5 μm or more and 18 μm or less, and still more preferably 6 μm or more and 15 μm or less. In such a mode, since the occupation volume of the negative electrode 140 in the lithium secondary battery 100 decreases, the lithium secondary battery 100 has a more improved energy density.

### (Electrolyte Solution)

The electrolyte solution contains an electrolyte and a solvent. It is a solution having ionic conductivity and serves as a conductive path of a lithium ion. The separator 130 may be impregnated with the electrolyte solution or the electrolyte solution may be encapsulated with a stacked body of the positive electrode 120, the separator 130, and the negative electrode 140 inside a hermetically sealing container.

The electrolyte solution according to the present embodiment contains, as a solvent, an ether not having a fluorine atom, a hydrofluoroether, and a saturated or unsaturated chain hydrofluorocarbon. Since the lithium secondary battery according to the present embodiment includes the electrolyte solution, it is possible to achieve both excellent cycle characteristic and stability against changes in environmental temperature. The factor is not necessarily clear, but for example, it is presumed as follows.

In general, in a case where an anode-free lithium secondary battery containing the electrolyte solution is charged and discharged, a solid electrolyte interfacial layer (SEI layer) is formed on a surface of the negative electrode or the like by decomposing the solvent or the like in the electrolyte solution. Due to the SEI layer in the lithium secondary battery, further decomposition of components in the electrolyte solution, irreversible reduction of lithium ions caused by the decomposition, generation of gas, and the like are suppressed. In addition, because the SEI layer has ionic conductivity, reactivity of lithium deposition reaction on the surface of the negative electrode, on which the SEI layer is formed, is uniform in a plane direction of the surface of the negative electrode. Therefore, promoting the formation of the SEI layer is very important for improving the performance of the anode-free lithium secondary battery.

It is presumed that the hydrofluoroether (which will hereinafter be called “HFE”) particularly high reactivity of fluorine in the vicinity of an ether bond due to the fact that a part of the structure is substituted with fluorine. Therefore, in the charge/discharge of the lithium secondary battery according to the present embodiment, it is presumed that a part of HFE easily reacts with the negative electrode and an SEI layer forming reaction based on this reaction is likely to occur, whereby an SEI layer with a high fluorine content is suitably formed.

In addition, it is presumed that, since the electrolyte solution contains the ether not having a fluorine atom, solubility of the electrolyte in the electrolyte solution is improved further, an internal resistance of the battery is reduced further, and properties of the SEI layer to be formed can be more suitable.

Furthermore, since the chain hydrofluorocarbon (which will hereinafter be called “HFC”) has a fluorine atom, it is easily dissolved in a mixed solvent of HFE and the ether not having a fluorine atom, and thus phase separation is unlikely to occur even in a case where the molecular weight is increased. Therefore, it is possible to add a solvent having a large molecular weight as the solvent, and it is possible to improve a boiling point of the electrolyte solution.

Accordingly, it is considered that, as the synergistic effect due to the characteristics of each of the aforesaid components, the lithium secondary battery 100 is unlikely to cause phase separation in the electrolyte solution and can have both excellent cycle characteristic and stability against changes in environmental temperature. The factor is however not limited to the aforesaid one.

The “hydrofluoroether” or “HFE” as used herein means an ether compound having at least one fluorine atom and a hydrogen atom.

The “hydrofluorocarbon” or “HFC” as used herein means a hydrocarbon compound having at least one fluorine atom and a hydrogen atom.

“Chain hydrocarbon skeleton” as used herein means a structure of a hydrocarbon chain formed by bonding a plurality of carbon atoms in a chain, and is intended to exclude a cyclic hydrocarbon skeleton.

A molecular weight of the hydrofluoroether (HFE) contained in the electrolyte solution according to the present embodiment is not particularly limited, and is, for example, 100 or more and 500 or less. From the standpoint of further improving the stability of the lithium secondary battery against changes in environmental temperature, the molecular weight of HFE is preferably 120 or more and 450 or less, more preferably 140 or more and 400 or less, still more preferably 160 or more and 350 or less, and even more preferably 180 or more and 300 or less.

The number of carbon atoms in HFE is not particularly limited, and for example, it is 3 or more and 30 or less. In addition, from the standpoint of improving the cycle characteristic and/or the stability of the battery, the number of carbon atoms in HFE is preferably 4 or more, 5 or more, or 6 or more, and from a similar standpoint, the number of carbon atoms therein is preferably 25 or less, 20 or less, 15 or less, or 10 or less.

The number of fluorine atoms in HFE is not particularly limited, and is, for example, 1 or more and 45 or less. From the standpoint of improving the cycle characteristic and/or the stability of the battery, the number of fluorine atoms in HFE is preferably 3 or more and 40 or less, more preferably 5 or more and 30 or less, still more preferably 6 or more and 20 or less, and even more preferably 7 or more and 15 or less.

The number of ether bonds in HFE is not particularly limited, and is, for example, 1 or more and 10 or less. From the standpoint of improving the cycle characteristic and/or the stability of the battery, the number of ether bonds in HFE is preferably 1 or more and 5 or less and more preferably 1 or more and 2 or less.

The HFE contained in the electrolyte solution according to the present embodiment preferably has a structure represented by Formula (1). In Formula (1), R_{F} is a fluorinated saturated or unsaturated monovalent hydrocarbon group, R¹ is a hydrogen atom or an alkyl group, and R² is a saturated or unsaturated monovalent hydrocarbon group which may be fluorinated.

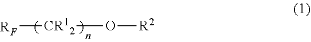

In Formula (1), R_{F} is not particularly limited insofar as it is a fluorinated saturated or unsaturated monovalent hydrocarbon group, and is, for example, a linear or branched alkyl group, alkenyl group, or alkynyl group having 1 to 5 carbon atoms, which has at least one fluorine atom. R_{F} is preferably a linear or branched alkyl group having 1 to 5 carbon atoms, which has at least one fluorine atom, and more preferably a linear or branched alkyl group having 1 to 3 carbon atoms, which has at least one fluorine atom. The number of fluorine atoms in R_{F} is not particularly limited insofar as it is 1 or more, and is, for example, 1 or more and 10 or less, preferably 1 or more and 5 or less and more preferably 2 or more and 4 or less.

From the standpoint of improving the cycle characteristic of the battery, R_{F} is preferably a fluorinated methyl group or a fluorinated ethyl group, and more preferably a trifluoromethyl group, a tetrafluoroethyl group, or a pentafluoroethyl group.

In Formula (1), R¹ is not particularly limited insofar as it is a hydrogen atom or an alkyl group. In a case where R¹ is an alkyl group, the number of carbon atoms therein is not particularly limited, and is, for example, 1 to 5, preferably 1 to 3 and more preferably 1 or 2. The alkyl group does not have a fluorine atom.

From the standpoint of improving the cycle characteristic of the battery, R¹ is preferably a hydrogen atom.

In Formula (1), R² is not particularly limited insofar as it is a saturated or unsaturated monovalent hydrocarbon group which may be fluorinated, and is, for example, a linear or branched alkyl group, alkenyl group, or alkynyl group having 1 to 5 carbon atoms, which may have a fluorine atom. R² is preferably a linear or branched alkyl group having 1 to 5 carbon atoms, which has at least one fluorine atom, and more preferably a linear or branched alkyl group having 1 to 3 carbon atoms, which has at least one fluorine atom. The number of fluorine atoms in R² is not particularly limited, and is, for example, 0 or more and 10 or less, preferably 1 or more and 6 or less and more preferably 2 or more and 5 or less.

From the standpoint of improving the cycle characteristic of the battery, R² is preferably a fluorinated methyl group or a fluorinated ethyl group, more preferably a trifluoromethyl group, a trifluoroethyl group, a tetrafluoroethyl group, or a pentafluoroethyl group, and still more preferably a trifluoromethyl group, a 2,2,2-trifluoroethyl group, a 1,1,2,2-tetrafluoroethyl group, or a pentafluoroethyl group.

In Formula (1), n is not particularly limited insofar as it is an integer of 1 or more and 5 or less. From the standpoint of improving the cycle characteristic of the battery, n in Formula (1) is preferably 1 or more and 4 or less, more preferably 1 or more and 3 or less, and still more preferably 1 or more and 2 or less.

It is preferable that the HFE contained in the electrolyte solution according to the present embodiment has at least one of a structure represented by Formula (2) or a structure represented by Formula (3). In a case where the electrolyte solution containing HFE as described above is used in the lithium secondary battery, there is a tendency that a high-quality SEI layer is formed on the surface of the negative electrode. From the standpoint, it is preferable that the HFE contained in the electrolyte solution according to the present embodiment has both of Formulae (2) and (3). In addition, the HFE may have a plurality of structures of at least one of Formula (2) or (3).

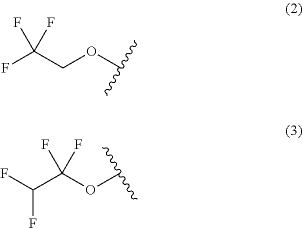 [SMILES: *OCC(F)(F)F ; *OC(F)(F)C(F)F]

In Formulae (2) and (3), a wavy line represents a bonding site in a monovalent group.

In a case where the HFE contained in the electrolyte solution according to the present embodiment has at least one of the structure represented by Formula (2) or the structure represented by Formula (3), the HFE is more preferably a compound represented by Formula (2′) or (3′). In Formulae (2′) and (3′), the definitions and preferred aspects of R¹, R², R_{F}, and n are the same as those in Formula (1) described above.

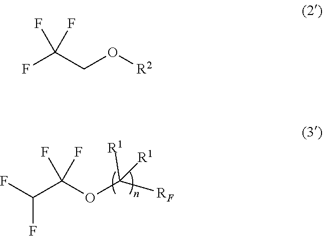

The HFE in the present embodiment is not particularly limited, and examples thereof include 1,1,2,2-tetrafluoroethyl-2,2,2-trifluoroethyl ether, bis(2,2,2-trifluoroethyl) ether, 1,1,2,2-tetrafluoroethyl-2,2,3,3-tetrafluoropropyl ether, 1,1,2,2-tetrafluoroethyl-2,2,2-trifluoroethyl ether, ethyl-1,1,2,2-tetrafluoroethyl ether, methyl-1,1,2,2-tetrafluoroethyl ether, 1H,1H,5H-octafluoropentyl-1,1,2,2-tetrafluoroethyl ether, difluoromethyl-2,2,3,3-tetrafluoropropyl ether, methyl perfluorobutyl ether, and ethyl perfluorobutyl ether. From the standpoint of further improving the cycle characteristic of the lithium secondary battery, 1,1,2,2-tetrafluoroethyl-2,2,2-trifluoroethyl ether or bis(2,2,2-trifluoroethyl) ether is preferable as the HFE.

The chain hydrofluorocarbon (HFC) contained in the electrolyte solution according to the present embodiment is not particularly limited insofar as it is a saturated or unsaturated chain hydrofluorocarbon, but a molecular weight thereof is preferably 200 or more and 800 or less. From the standpoint of further improving the stability of the lithium secondary battery against changes in environmental temperature, the molecular weight of the chain HFC is more preferably 225 or more and 700 or less, still more preferably 250 or more and 650 or less, even more preferably 275 or more and 630 or less, and particularly preferably 300 or more and 600 or less.

In the chain HFC contained in the electrolyte solution according to the present embodiment, a ratio (F/(F+H)) of the number (F) of fluorine atoms to the total number (F+H) of fluorine atoms and hydrogen atoms is not particularly limited, but for example, it is 0.30 or more and less than 1.0. From the standpoint of more excellent balance between the cycle characteristic and the stability against changes in environmental temperature of the lithium secondary battery, the aforesaid ratio (F/(F+H)) is preferably 0.40 or more and 0.95 or less, more preferably 0.50 or more and 0.90 or less, still more preferably 0.60 or more and 0.90 or less, and even more preferably 0.65 or more and 0.90 or less.

The chain HFC contained in the electrolyte solution according to the present embodiment may have a carbon atom chain portion not having a fluorine atom. In a case where the electrolyte solution contains the chain HFC, the electrolyte solution tends to have excellent compatibility. It is preferable that the chain HFC has a structure in which a carbon atom chain portion having a fluorine atom and a carbon atom chain portion not having a fluorine atom are linked.

In the above-described aspect, the number of carbon atoms in the carbon atom chain portion not having a fluorine atom is not particularly limited, and may be, for example, 1 or more and 8 or less, 2 or more and 6 or less, or 2 or more and 4 or less. In the above-described aspect, the number of carbon atoms in the carbon atom chain portion having a fluorine atom is not particularly limited, and may be, for example, 2 or more and 15 or less, 3 or more and 12 or less, or 4 or more and 10 or less.

The number of fluorine atoms contained in the chain HFC is not particularly limited, and is, for example, 4 or more and 50 or less. From the standpoint of improving the stability of the battery against changes in environmental temperature, the number of fluorine atoms contained in the chain HFC is preferably 6 or more and 40 or less, more preferably 8 or more and 30 or less, still more preferably 10 or more and 25 or less, and even more preferably 12 or more and 20 or less.

The number of carbon atoms in the chain HFC is not particularly limited, and for example, it is 4 or more and 30 or less. In addition, from the standpoint of improving the cycle characteristic and/or the stability of the battery, the number of carbon atoms in the chain HFC is preferably 5 or more, 6 or more, 7 or more, 8 or more, or 9 or more, and from a similar standpoint, the number of carbon atoms therein is preferably 25 or less, 20 or less, 15 or less, or 12 or less.

The chain HFC in the present embodiment is not particularly limited, and examples thereof include (perfluoro-n-hexyl)ethane, 1H,1H,2H-heptadecafluoro-1-decene, 1-(perfluoro-n-hexyl)tetradecane, 2H,3H-decafluoropentane, eicosafluorononane, hexadecafluoroheptane, hexacosafluorododecane, octadecafluorooctane, (perfluorohexyl)ethylene, and 1H-tridecafluorohexane. From the standpoint of more excellent balance between the cycle characteristic and the stability against changes in environmental temperature of the lithium secondary battery, (perfluoro-n-hexyl)ethane or 1H,1H,2H-heptadecafluoro-1-decene is preferable as the chain HFC.

The electrolyte solution according to the present embodiment may contain a compound substituted with at least one fluorine atom (which will hereinafter be called “fluorine-substituted compound”) other than the HFE and chain HFC described above. The fluorine-substituted compound other than the HFE and chain HFC is not particularly limited, and examples thereof include a fluorine-substituted compound having an ester group, a carbonate group, a carbonyl group, and/or a ketone group. In addition, the electrolyte solution may contain a fluorine-substituted compound not having a hydrogen atom. The aforesaid fluorine-substituted compound is not particularly limited, and examples thereof include a hydrocarbon in which all substituents are substituted with fluorine, and a hydrocarbon in which all substituents are substituted with chlorine or fluorine.

Further, the electrolyte solution may contain a cyclic HFC. The cyclic HFC is not particularly limited, and examples thereof include 1,1,2,2,3,3,4-heptafluorocyclopentane, hexadecafluoro(1,3-dimethylcyclohexane), tetradecafluoromethylcyclohexane, fluorocyclohexane, fluorocyclopentane, octadecafluorodecahydronaphthalene, and octafluoronaphthalene.

The number of carbon atoms in the ether compound not having a fluorine atom (which will hereinafter be called “non-fluorinated ether compound”), which is contained in the electrolyte solution, is not particularly limited, and is, for example, 2 or more and 20 or less. From the standpoint of further improving the solubility of the electrolyte in the electrolyte solution, the number of carbon atoms in the non-fluorinated ether compound is preferably 3 or more and 15 or less, more preferably 4 or more and 12 or less, and still more preferably 5 or more and 10 or less.

The non-fluorinated ether compound is not particularly limited, and examples thereof include triethylene glycol dimethyl ether, 1,2-dimethoxyethane, 1,1-dimethoxyethane, diethylene glycol dimethyl ether, tetrahydrofuran, tetrahydropyran, dioxolane, dioxane, 4-methyl-1,3-dioxane, oxetane, and hexamethylene oxide. From the standpoint of further improving the solubility of the electrolyte in the electrolyte solution, the non-fluorinated ether compound is preferably a compound having two, three, four, five, six, seven, or eight ether bonds, more preferably 1,2-dimethoxyethane, diethylene glycol dimethyl ether, or triethylene glycol dimethyl ether, and still more preferably 1,2-dimethoxyethane.

A content of HFE in the electrolyte solution is not particularly limited, and is, for example, 40% by volume or more and 90% by volume or less with respect to the total amount of solvent components. From the standpoint of further improving the cycle characteristic of the lithium secondary battery, the content of HFE is preferably 45% by volume or more and 85% by volume or less, more preferably 50% by volume or more and 80% by volume or less, still more preferably 55% by volume or more and 75% by volume or less, and even more preferably 60% by volume or more and 70% by volume or less with respect to the total amount of the solvent components.

A content of the chain HFC in the electrolyte solution is not particularly limited, and is, for example, 1.0% by volume or more and 60% by volume or less with respect to the total amount of the solvent components. From the standpoint of more excellent balance between the cycle characteristic and the stability against changes in environmental temperature of the lithium secondary battery, the content of the chain HFC is preferably 3.0% by volume or more and 55% by volume or less, more preferably 5.0% by volume or more and 50% by volume or less, still more preferably 7.0% by volume or more and 45% by volume or less, and even more preferably 10% by volume or more and 40% by volume or less with respect to the total amount of the solvent components.

In the electrolyte solution according to the present embodiment, the total content of fluorinated solvents is not particularly limited, and is, for example, 30% by volume or more with respect to the total amount of the solvent components. From the standpoint of more excellent balance between the cycle characteristic and the stability against changes in environmental temperature of the lithium secondary battery, the total content of the fluorinated solvents is preferably 40% by volume or more, more preferably 50% by volume or more or more than 50% by volume, still more preferably 60% by volume or more, even more preferably 70% by volume or more, and particularly preferably 75% by volume or more with respect to the total amount of the solvent components.

The total content of the ether not having a fluorine atom in the electrolyte solution is not particularly limited, and for example, it is 1.0% by volume or more and 60% by volume or less with respect to the total amount of the solvent components in the electrolyte solution. From the standpoint of more excellent balance between the cycle characteristic and the stability against changes in environmental temperature of the lithium secondary battery, the content of the ether not having a fluorine atom is preferably 3.0% by volume or more and 50% by volume or less, more preferably 5.0% by volume or more and 45% by volume or less, still more preferably 7.0% by volume or more and 40% by volume or less, and even more preferably 10% by volume or more and 30% by volume or less with respect to the total amount of the solvent components in the electrolyte solution.

As the solvent of the electrolyte solution, any solvents other than the aforesaid compounds can be freely combined and used with the aforesaid compounds insofar as the solvent include the non-fluorinated ether compound, HFE, and chain HFC. In addition, for each of the non-fluorinated ether compound, HFE, and chain HFC, one kind may be used alone or two or more kinds thereof may be used in combination.

A boiling point of the electrolyte solution according to the present embodiment is preferably 60° C. or higher. From the standpoint of further improving the stability of the lithium secondary battery against changes in environmental temperature, particularly against a high temperature, the boiling point of the electrolyte solution is preferably 65° C. or higher, more preferably 70° C. or higher, still more preferably 74° C. or higher, even more preferably 80° C. or higher, and particularly preferably 90° C. or higher.

There are no particular restrictions on the electrolyte which is contained in the electrolyte solution insofar as it is a salt. Examples of the electrolyte include salts of Li, Na, K, Ca, and Mg. As the electrolyte, a lithium salt is preferred.

The lithium salt is not particularly limited, and examples thereof include LiI, LiCl, LiBr, LiF, LiBF₄, LiPF₆, LiAsF₆, LiSO₃CF₃, LiN(SO₂F)₂, LiN(SO₂CF₃)₂, LiN(SO₂CF₂CF₃)₂, LiBF₂(C₂O₄), LiB(O₂C₂H₄)₂, LiB(O₂C₂H₄)F₂, LiB(OCOCF₃)₄, LiNO₃, and Li₂SO₄. The lithium salt is preferably LiN(SO₂F)₂ from the standpoint of providing a lithium secondary battery 100 having more excellent energy density and cycle characteristic. In addition, in a case where the electrolyte solution contains LiN(SO₂F)₂, the formation and growth of the SEI layer on the surface of the negative electrode are further promoted, and it is possible to obtain a lithium secondary battery having more excellent cycle characteristic. One or more of the aforesaid lithium salts are used alone or in combination.

A concentration of the electrolyte in the electrolyte solution is not particularly limited, but is preferably 0.50 M or more, more preferably 0.70 M or more, still more preferably 0.90 M or more, and even more preferably 1.0 M or more. When the concentration of the electrolyte is within the above-described range, the SEI layer is more easily formed and the internal resistance tends to be further reduced. In particular, in the lithium secondary battery containing the fluorine compound as the solvent, the concentration of the electrolyte in the electrolyte solution can be increased, so that the cycle characteristic and rate capability can be improved further. The upper limit of the concentration of the electrolyte is not particularly limited, and the concentration of the electrolyte may be 10 M or less, 5.0 M or less, or 2.0 M or less.

The lithium secondary battery according to the present embodiment may contain the electrolyte solution or the components of the electrolyte solution in a state other than the liquid. For example, by using an electrolyte solution and a polymer when preparing the separator described later, a battery can be obtained in which the electrolyte solution is contained in a solid or semi-solid (gel) member. The electrolyte solution can be replaced by the electrolyte.

The fact that the electrolyte solution contains the non-fluorinated ether compound, the HFE, and the chain HFC can be confirmed by various conventionally known methods. Examples of such a method include an NMR measurement method, a mass analysis method such as HPLC-MS, and an IR measurement method.

### (Separator)

The separator 130 is a member for separating the positive electrode 120 from the negative electrode 140 to prevent a short circuit of the battery and in addition, for securing the ionic conductivity of a lithium ion which serves as a charge carrier between the positive electrode 120 and the negative electrode 140. That is, the separator 130 has a function of physically and/or electrically separating the positive electrode 120 and the negative electrode 140, and a function of securing ionic conductivity of lithium ions. Therefore, the separator 130 is formed of a material that does not have electronic conductivity and does not react with lithium ions. In addition, the separator 130 may play a role of holding the electrolyte solution.

As such a separator, one member having the aforesaid two functions may be used singly, or two or more members each having the aforesaid one function may be used in combination. The separator is not particularly limited insofar as it has the aforesaid functions, and examples thereof include a porous member having insulating properties, a polymer electrolyte, a gel electrolyte, and an inorganic solid electrolyte. Typically, it is at least one selected from the group consisting of a porous member having insulating properties, a polymer electrolyte, and a gel electrolyte.

In a case where the separator includes an insulating porous member, the member exhibits ionic conductivity by filling pores of the member with a material having ionic conductivity. Examples of the material to be filled include the electrolyte solution, polymer electrolyte, and gel electrolyte described above.

As the separator 130, one or more of the insulating porous member, the polymer electrolyte, or the gel electrolyte may be used alone or in combination. In a case where the insulating porous member is used alone as the separator, the lithium secondary battery needs to further include the electrolyte solution.

A material constituting the aforesaid insulating porous member is not particularly limited, and examples thereof include an insulating polymer material, and specific examples thereof include polyethylene (PE) and polypropylene (PP). That is, the separator 130 may be a porous polyethylene (PE) film, a porous polypropylene (PP) film, or a stacked structure thereof.

The separator 130 may be covered with a separator coating layer. The separator coating layer may cover both of the surfaces of the separator 130 or may cover only one of them. The separator coating layer is not particularly limited insofar as it is a member having ionic conductivity and being not reactive with lithium ions, and is preferably capable of firmly adhering the separator 130 to a layer adjacent to the separator 130. Such a separator coating layer is not particularly limited, and examples thereof include members containing a binder such as polyvinylidene fluoride (PVDF), a composite material (SBR-CMC) of styrene butadiene rubber and carboxymethyl cellulose, polyacrylic acid (PAA), lithium polyacrylate (Li-PAA), polyimide (PI), polyamideimide (PAI), or aramid. The separator coating layer may contain inorganic particles such as silica, alumina, titania, zirconia, magnesium oxide, magnesium hydroxide, and lithium nitrate in the above-described binder. The separator 130 may be a separator having no separator coating layer, or a separator having the separator coating layer.

An average thickness of the separator 130 including the separator coating layer is preferably 30 μm or less, more preferably 25 μm or less, and still more preferably 20 μm or less. In such a mode, the occupation volume of the separator 130 in the lithium secondary battery 100 decreases and therefore, the resulting lithium secondary battery 100 has a more improved energy density. In addition, the average thickness of the separator 130 is preferably 5.0 μm or more, more preferably 7.0 μm or more, and still more preferably 10 μm or more. In such a mode, the positive electrode 120 and the negative electrode 140 can be separated more reliably, and short circuiting of the battery can be further suppressed.

### (Positive Electrode)

The positive electrode 120 is not particularly limited insofar as it is a positive electrode commonly used in a lithium secondary battery, and a known material can be selected as needed, depending on the use of the lithium secondary battery. From the standpoint of improving the stability and output voltage of the battery, the positive electrode 120 preferably has a positive-electrode active material.

In a case where the positive electrode has a positive-electrode active material, typically, lithium ions are filled into and extracted from the positive-electrode active material by the charge/discharge of the battery.

The “positive-electrode active material” as used herein is a substance that causes an electrode reaction, that is, an oxidation reaction and a reduction reaction at the positive electrode. Specifically, examples of the positive-electrode active material include a host material for a lithium element (typically, lithium ions).

Such a positive-electrode active material is not particularly limited, and examples thereof include metal oxides and metal phosphates. The metal oxides are not particularly limited, and examples thereof include cobalt oxide-based compounds, manganese oxide-based compounds, and nickel oxide-based compounds. The metal phosphates are not particularly limited, and examples thereof include iron phosphate-based compounds and cobalt phosphate-based compounds. Examples of typical positive-electrode active materials include LiCoO₂, LiNiₓCo_{y}Mn_{z}O (x+y+z=1), LiNiₓCo_{y}Al_{z}O (x+y+z=1), LiNiₓMn_{y}O (x+y=1), LiNiO₂, LiMn₂O₄, LiFePO, LiCoPO, LiFeOF, LiNiOF, and LiTiS₂. One or more of the positive-electrode active materials may be used alone or in combination.

The positive electrode 120 may contain components other than the aforesaid positive-electrode active material. Such a component is not particularly limited, and examples thereof include a conductive aid, a binder, a gel electrolyte, and a polymer electrolyte.

The positive electrode 120 may be a gel electrolyte. In such a mode, adhesion force between the positive electrode and the positive electrode current collector is improved by a function of the gel electrolyte, and it is possible to attach a thinner positive electrode current collector, and thus it is possible to further improve the energy density of the battery. In a case of attaching the positive electrode current collector to a surface of the positive electrode, a positive electrode current collector formed on a release paper may be used.

Examples of conductive aids that can be used in the positive electrode 120 include, but are not limited to, carbon black, single-wall carbon nanotubes (SWCNT), multi-wall carbon nanotubes (MWCNT), carbon nanofibers (CF), and acetylene black. The binder is not particularly limited, and examples thereof include polyvinylidene fluoride, polytetrafluoroethylene, styrene butadiene rubber, acrylic resins, and polyimide resins.

The content of the positive-electrode active material in the positive electrode 120 may be, for example, 50% by mass or more and 100% by mass or less based on the total amount of the positive electrode 120. The content of the conductive aid may be, for example, 0.50% by mass or more and 30% by mass or less based on the total amount of the positive electrode 120. The content of the binder may be, for example, 0.50% by mass or more and 30% by mass or less based on the total amount of the positive electrode 120. A content of the gel electrolyte or the polymer electrolyte may be, for example, 0.50% by mass or more and 30% by mass or less, and preferably 5.0% by mass or more and 20% by mass or less and more preferably 8.0% by mass or more and 15% by mass or less with respect to the entire positive electrode 120.

An average thickness of the positive electrode 120 is preferably 20 μm or more and 100 μm or less, more preferably 30 μm or more and 80 μm or less, and still more preferably 40 μm or more and 70 μm or less. However, the average thickness of the positive electrode can be appropriately adjusted according to a desired capacity of the battery.

### (Positive Electrode Current Collector)

The positive electrode current collector 110 is disposed on one side of the positive electrode 120. The positive electrode current collector is not particularly limited insofar as it is a conductor not reactive with a lithium ion in the battery. Examples of such a positive electrode current collector include aluminum. The positive electrode current collector 110 may not be provided, and in this case, the positive electrode itself acts as a current collector. The positive electrode current collector functions to transfer electrons to the positive electrode (in particular, the positive-electrode active material). The positive electrode current collector 110 is in physical and/or electrical contact with the positive electrode 120.

In the present embodiment, an average thickness of the positive electrode current collector is preferably 1.0 μm or more and 15 μm or less, more preferably 2.0 μm or more and 10 μm or less, and still more preferably 3.0 μm or more and 6.0 μm or less. In such a mode, the occupation volume of the positive electrode current collector in the lithium secondary battery 100 decreases and the resulting lithium secondary battery 100 therefore has a more improved energy density.

### (Use of Lithium Secondary Battery)

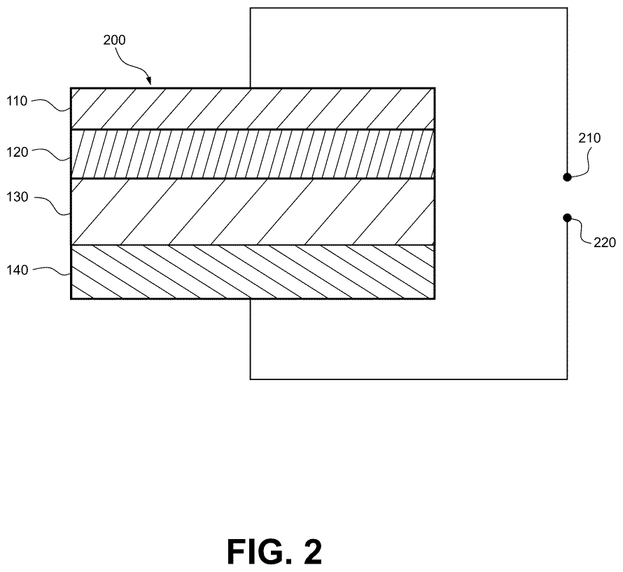

FIG. 2 shows one mode of the use of the lithium secondary battery according to the present embodiment. The lithium secondary battery 200 has a positive electrode terminal 210 and a negative electrode terminal 220 for connecting the lithium secondary battery 200 to an external circuit and these terminals are bonded to a positive electrode current collector 110 and the negative electrode 140, respectively. The lithium secondary battery 200 is charged and discharged by connecting the negative electrode terminal 220 to one end of the external circuit and the positive electrode terminal 210 to the other end of the external circuit.

The lithium secondary battery 200 is charged by applying a voltage between the positive electrode terminal 210 and the negative electrode terminal 220 to cause a current flow from the negative electrode terminal 220 (negative electrode 140) to the positive electrode terminal 210 (positive electrode 120) through the external circuit. In the lithium secondary battery 200, it is presumed that the solid electrolyte interfacial layer (SEI layer) is formed on the surface of the negative electrode 140 (at the interface between the negative electrode 140 and the separator 130) by initial charge, but the lithium secondary battery 200 may not have the SEI layer. By charging the lithium secondary battery 200, the lithium metal deposits on the interface between the negative electrode 140 and the SEI layer, on the interface between the negative electrode 140 and the separator 130, and/or on the interface between the SEI layer and the separator 130.

When the positive electrode terminal 210 and the negative electrode terminal 220 are connected to the desired charged lithium secondary battery 200 through the external circuit, the lithium secondary battery 200 is discharged. As a result, the deposition of the lithium metal generated on the negative electrode is electrolytically dissolved. When the SEI layer is formed in the lithium secondary battery 200, the deposition of lithium metal generated at least at the interface between the negative electrode 140 and the SEI layer and/or the interface between the SEI layer and the separator 130 is electrolytically dissolved.

### (Method of Manufacturing Lithium Secondary Battery)

A method of manufacturing the lithium secondary battery 100 as shown in FIG. 1 is not particularly limited insofar as it can provide a lithium secondary battery equipped with the aforesaid structure and examples of the method include the method as follows.

The positive electrode current collector 110 and the positive electrode 120 are produced, for example, in the following manner. The aforesaid positive-electrode active material, conductive aid, and binder are mixed to obtain a positive electrode mixture. The mixing ratio may be, for example, 50% by mass or more and 99% by mass or less of the positive-electrode active material, 0.5% by mass or more and 30% by mass or less of the conductive aid, and 0.5% by mass or more and 30% by mass or less of the binder based on the total amount of the aforesaid positive electrode mixture. The positive electrode mixture thus obtained is applied to one of the surfaces of a metal foil (for example, Al foil) serving as a positive electrode current collector and having a predetermined thickness (for example, 5.0 μm or more and 1.0 mm or less), followed by press molding. The molded product thus obtained is punched into a predetermined size to obtain a positive electrode current collector 110 and a positive electrode 120.

Next, the aforesaid negative electrode material, for example, a metal foil (such as an electrolytic Cu foil) having a thickness of 1.0 μm or more and 1.0 mm or less is washed with a sulfamic-acid-containing solvent, punched into a predetermined size, ultrasonically washed with ethanol, and then dried to obtain a negative electrode 140.

Next, a separator 130 having the aforesaid structure is formed. As the separator 130, a separator produced by a conventionally known method or a commercially available one may be used.

Next, the electrolyte solution is prepared by dissolving a lithium salt in a solution obtained by mixing at least one of the aforesaid non-fluorinated ether compound, HFE, and chain HFC, and optionally other compounds, using the solution as a solvent. The mixing ratio of the solvent and the lithium salt may be appropriately adjusted so that the content or concentration of each solvent and lithium salt in the electrolyte solution falls within the aforesaid ranges.

The positive electrode current collector 110 on which the positive electrode 120 is formed, the separator 130, and the negative electrode 140 obtained as described above are stacked in this order such that the positive electrode 120 faces the separator 130 to obtain a stacked body. The stacked body thus obtained is encapsulated, together with the electrolyte solution in a hermetically sealing container to obtain a lithium secondary battery 100. The hermetically sealing container is not particularly limited, and examples thereof include a laminate film.

### Modified Examples

The aforesaid embodiments are examples for describing the present invention. They do not intend to limit the present invention only thereto and the present invention may have various modifications without departing from the gist thereof.

For example, from the lithium secondary battery 100, the separator 130 may be omitted. In this case, it is preferable to fix the positive electrode 120 and the negative electrode 140 in a state of being sufficiently separated from each other so that the positive electrode 120 and the negative electrode 140 do not come into contact with each other physically or electrically.

In the lithium secondary battery according to the present embodiment, a current collector may be provided on the surface of the negative electrode placed so as to be in contact with the negative electrode. Such a current collector is not particularly limited, and examples thereof include those usable as a negative electrode material. When the lithium secondary battery has neither a positive electrode current collector nor a negative electrode current collector, the positive electrode or the negative electrode itself serves as a current collector.

On the surface of the negative electrode in the lithium secondary battery of the present embodiment, a part or all of the surface facing the separator may be coated with a coating agent. Examples of the negative electrode coating agent include benzotriazole (BTA), imidazole (IM), triazinethiol (TAS), and derivatives of these compounds. For example, after washing the aforesaid negative electrode material, the negative electrode material is immersed in a solution containing the negative electrode coating agent (for example, a solution in which the negative electrode coating agent is contained in an amount of 0.01% by volume or more and 10% by volume or less), and dried in the atmosphere, whereby the negative electrode material can be coated with the negative electrode coating agent. It is presumed that the coating of the aforesaid compound suppresses non-uniform deposition of lithium metal on the surface of the negative electrode and suppresses the growth of a lithium metal deposited on the negative electrode into dendrite form.

The lithium secondary battery according to the present embodiment may have, at the positive electrode current collector and/or negative electrode, a terminal for connecting it to an external circuit. For example, a metal terminal (for example, Al, Ni, or the like) having a length of 10 μm or more and 1.0 mm or less may be bonded to one or both of the positive electrode current collector and the negative electrode. For bonding, a conventionally known method may be used and for example, ultrasonic welding is usable.

The term “an energy density is high” or “has a high energy density” as used herein means that the capacity of a battery per total volume or total mass is high. It is preferably 700 Wh/L or more or 300 Wh/kg or more, more preferably 800 Wh/L or more or 350 Wh/kg or more, and still more preferably 900 Wh/L or more or 400 Wh/kg or more.

The term “having an excellent cycle characteristic” as used herein means that a decreasing ratio of the capacity of a battery is small before and after the expected number of charge/discharge cycles in ordinary use. Described specifically, it means that when a first discharge capacity after the initial charge/discharge and a capacity after the number of charge/discharge cycles expected in ordinary use are compared, the capacity after charge/discharge cycles has hardly decreased compared with the first discharge capacity after the initial charge/discharge. The “number expected in ordinary use” varies depending on the usage of the lithium secondary battery and it is, for example, 30 times, 50 times, 70 times, 100 times, 300 times, or 500 times. The term “capacity after charge/discharge cycles hardly decreased compared with the first discharge capacity after the initial charge/discharge” means, though differing depending on the usage of the lithium secondary battery, that the capacity after charge/discharge cycles is, for example, 60% or more, 65% or more, 70% or more, 75% or more, 80% or more, or 85% or more, each in the first discharge capacity after the initial charge/discharge.

A numerical range described as a preferred range or the like as used herein may be replaced with a numerical range obtained by arbitrarily combining the described upper limit value and lower limit value. For example, in a case where a certain parameter is preferably 50 or more and more preferably 60 or more, and is preferably 100 or less and more preferably 90 or less, the parameter may be any of 50 or more and 100 or less, 50 or more and 90 or less, 60 or more and 100 or less, or 60 or more and 90 or less.

### EXAMPLES

The present invention will hereinafter be described in detail by Examples and Comparative Examples. The present invention is not limited by the following test examples.

### Example 1

A lithium secondary battery of Example 1 was formed as follows.

### (Formation of Negative Electrode)

First, an electrolytic Cu foil having a thickness of 8.0 μm was washed with a solvent containing sulfamic acid, and then washed with water. Subsequently, the electrolytic Cu foil was immersed in a solution containing 1H-benzotriazole as a negative electrode coating agent, dried, and further washed with water to obtain a Cu foil coated with the negative electrode coating agent.

### (Formation of Positive Electrode)

A positive electrode was formed. A mixture of 96 parts by mass LiNi_{0.85}Co_{0.12}Al_{0.03}O₂ positive-electrode active material, 2.0 parts by mass carbon black conductive aid, and 2.0 parts by mass polyvinylidene fluoride (PVDF) binder was applied to one surface of 12 μm-thick Al foil and press-molded. The molded product thus obtained was punched to a predetermined size (40 mm×40 mm) to obtain a positive electrode which had a positive electrode current collector on one surface.

### (Formation of Separator)

As a separator, that obtained by coating 2.0-μm polyvinylidene fluoride (PVDF) on both surfaces of a 12-μm polyethylene microporous membrane and having a predetermined size (50 mm×50 mm) was formed.

### (Preparation of Electrolyte Solution)

An electrolyte solution was prepared as follows. Three kinds of solvents of 1,1,2,2-tetrafluoroethyl-2,2,2-trifluoroethyl ether, (perfluoro-n-hexyl)ethane, and 1,2-dimethoxyethane were mixed with each other in an amount of 70% by volume of 1,1,2,2-tetrafluoroethyl-2,2,2-trifluoroethyl ether, 10% by volume of (perfluoro-n-hexyl)ethane, and 20% by volume of 1,2-dimethoxyethane. An electrolyte solution was obtained by dissolving LiN(SO₂F)₂ in the resulting mixed solution so as to have a molar concentration of 1.0 M.

### (Assembly of Battery)

The positive electrode current collector on which the positive electrode was formed, the separator, and the negative electrode obtained as described above were stacked in this order such that the positive electrode faced the separator to obtain a stacked body. Further, a 100-μm Al terminal and 100-μm Ni terminal were bonded to the positive electrode current collector and the negative electrode, respectively by ultrasonic welding and then the bonded body was inserted into a laminate-film outer container. Then, the electrolyte solution prepared as described above was injected in the outer container. The resulting outer container was sealed to obtain a lithium secondary battery.

### Examples 2 to 5

Lithium secondary batteries were obtained in the same manner as in Example 1, except that the electrolyte solutions were prepared using the solvents described in Table 1.

### Comparative Examples 1 and 5

Lithium secondary batteries were obtained in the same manner as in Example 1, except that the electrolyte solutions were prepared using the solvents described in Table 2. Comparative Examples did not contain one of hydrofluoroether (HFE) or chain hydrofluorocarbon (HFC), and Comparative Example 5 contained the cyclic HFC.

In Tables 1 and 2, “DME” represents 1,2-dimethoxyethane, “HFE1” represents 1,1,2,2-tetrafluoroethyl-2,2,2-trifluoroethyl ether represented by Formula (4), “HFE2” represents bis(2,2,2-trifluoroethyl) ether represented by Formula (5), “HFC1” represents (perfluoro-n-hexyl)ethane represented by Formula (6), “HFC2” represents 1H,1H,2H-heptadecafluoro-1-decene represented by Formula (7), and “HFC3” represents 1,1,2,2,3,3,4-heptafluorocyclopentane represented by Formula (8).

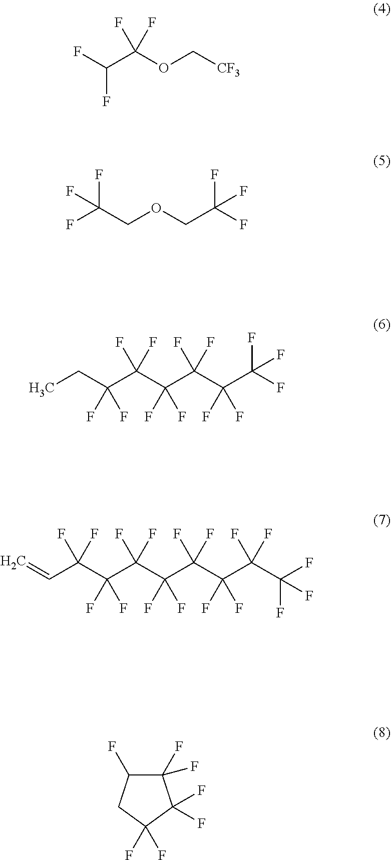 [SMILES: FC(F)C(F)(F)OCC(F)(F)F ; FC(F)(F)COCC(F)(F)F ; CCC(F)(F)C(F)(F)C(F)(F)C(F)(F)C(F)(F)C(F)(F)F ; C=CC(F)(F)C(F)(F)C(F)(F)C(F)(F)C(F)(F)C(F)(F)C(F)(F)C(F)(F)F ; FC1CC(F)(F)C(F)(F)C1(F)F]

In Tables 1 and 2, each solvent is classified into any of the ether not having a fluorine atom, the HFE, or the HFC in the above definitions, and the HFC is further classified into chain of cyclic. In addition, in Tables 1 and 2, a numerical value on the right side of each solvent is described as a content with respect to the total amount of solvents in units of % by volume. For example, in Table 1, it means that Example 1 contained 20% by volume of DME, 70% by volume of HFE1, and 10% by volume of HFC1. All Examples and Comparative Examples contained 1.0 M of LiN(SO₂F)₂ as the electrolyte.

### [Presence or Absence of Phase Separation]

After preparing the above-described electrolyte solution, the electrolyte solution was allowed to stand for 1 hour in an argon atmosphere, and then the presence or absence of phase separation was observed visually. In Tables 1 and 2, an item determined to have phase separation is indicated as “Phase separation”.

### [Evaluation According to UN38.3-T2 Test]

The UN38.3-T2 test is an international transport recommendation test of the United Nations for evaluating the stability of electrical connection inside the battery in a case of a rapid temperature change. With the lithium secondary batteries prepared in each of Examples and Comparative Examples, the UN38.3-T2 test was carried out as follows.

At a temperature of 25° C., the formed lithium secondary battery was CC-charged at 3.2 mA until the voltage reached 4.2 V, and then CC-discharged at 3.2 mA until the voltage reached 3.0 V. Next, a cycle of CC-charging at 13.6 mA until the voltage reached 4.2 V and then CC-discharging at 13.6 mA until the voltage reached 3.0 V was repeated for 25 cycles. Thereafter, CC-charging at 13.6 mA was performed until the voltage reached 4.2 V. The lithium secondary battery after the cycle test was stored at a test temperature of 72° C.±2° C. for 6 hours, and then within 30 minutes, it was stored at a test temperature of −40° C.±2° C. for 6 hours. After repeating such an operation 10 times, the lithium secondary battery was stored in an environment of 20±5° C. for 24 hours.

In the lithium secondary battery in which the above-described storage was completed, it was confirmed that abnormality such as breakage of the cell pack, liquid leakage, decomposition, weight loss of 0.2% by weight or more, and ignition did not occur, and it was further confirmed that an open circuit voltage (OCV) was not less than 90% with respect to the OCV before the above-described operation. In Tables 1 and 2, a case where the above-described abnormality or the above-described decrease in open circuit voltage occurred is indicated as “x”, and a case where the above-described abnormality or the above-described decrease in open circuit voltage did not occur is indicated as “-”.

### [Measurement of Discharge Capacity]

The formed lithium secondary battery was CC-charged at 3.2 mA until the voltage reached 4.2 V (initial charge), and then CC-discharged at 3.2 mA until the voltage reached 3.0 V (which will hereinafter be called “initial discharge”). Next, a cycle of CC-charging at 13.6 mA until the voltage reached 4.2 V and then CC-discharging at 13.6 mA until the voltage reached 3.0 V was repeated in an environment of a temperature of 25° C. or 0° C. The discharge capacity at the temperatures of 25° C. and 0° C. is shown in Tables 1 and 2.

### [Evaluation of Cycle Characteristic]

The cycle characteristic of each of the lithium secondary batteries formed in Examples and Comparative Examples was evaluated as follows.

The formed lithium secondary battery was subjected to initial charge and initial discharge. Next, a cycle of CC-charging at 13.6 mA until the voltage reached 4.2 V and then CC-discharging at 13.6 mA until the voltage reached 3.0 V was repeated at a temperature of 25° C. For the examples, the capacity was obtained from the initial discharge (referred to as “initial capacity”), and the number of cycles (described as “Number of cycles” in the tables) when the discharge capacity reached 80% of the initial capacity is shown in Tables 1 and 2.

TABLE 1

| | | Example 1 | Example 2 | Example 3 | Example 4 | Example 5 |
|---|---|---|---|---|---|---|
| Lithium salt | | 1.0M LiFSI | 1.0M LiFSI | 1.0M LiFSI | 1.0M LiFSI | 1.0M LiFSI |
| Ether not having | | DME: 20 | DME: 20 | DME: 20 | DME: 20 | DME: 20 |
| fluorine atom | | | | | | |
| HFE | | HFE1: 70 | HFE1: 60 | HFE2: 50 | HFE2: 60 | HFE2: 60 |
| HFC | Chain | HFC1: 10 | HFC1: 20 | HFC1: 30 | HFC1: 20 | HFC2: 20 |
| | Cyclic | — | — | — | — | — |

| | | | | | |
|---|---|---|---|---|---|
| HFC/(HFC + HFE) | 12.5% | 25.0% | 37.5% | 25.0% | 25.0% |
| volume fraction (%) | | | | | |
| Phase separation | — | — | — | — | — |
| T2 TEST | ◯ | ◯ | ◯ | ◯ | ◯ |
| Discharge capacity | 68 | 67 | 66 | 67 | 65 |
| at 25° C. (mAh) | | | | | |
| Discharge capacity | 48 | 47 | 46 | 47 | 46 |
| at 0° C. (mAh) | | | | | |
| Number of cycles | 155 | 160 | 158 | 150 | 144 |

TABLE 2

| | | Comparative | Comparative | Comparative | Comparative | Comparative |
|---|---|---|---|---|---|---|
| | | Example 1 | Example 2 | Example 3 | Example 4 | Example 5 |
| Lithium salt | | 1.0M LiFSI | 1.0M LiFSI | 1.0M LiFSI | 1.0M LiFSI | 1.0M LiFSI |
| Ether not having | | DME: 20 | DME: 20 | DME: 20 | DME: 20 | DME: 20 |
| fluorine atom | | | | | | |
| HFE | | — | — | HFE1: 80 | HFE2: 80 | HFE1: 60 |
| HFC | Chain | HFC1: 80 | HFC2: 80 | — | — | — |
| | Cyclic | — | — | — | — | HFC3: 20 |

| | | | | | |
|---|---|---|---|---|---|
| HFC/(HFC + HFE) | 100.0% | 100.0% | 0.0% | 0.0% | 0.0% |
| volume fraction (%) | | | | | |
| Phase separation | Phase | Phase | — | — | — |
| | separation | separation | | | |
| T2 TEST | — | — | X | X | X |
| Discharge capacity | — | — | 68 | 65 | 65 |
| at 25° C. (mAh) | | | | | |
| Discharge capacity | — | — | 48 | 46 | 7 |
| at 0° C. (mAh) | | | | | |
| Number of cycles | — | — | 152 | 143 | 143 |

In Tables 1 and 2, “-” in the components of the electrolyte solution indicates that the corresponding component was not contained, and “-” in the test results indicates that the corresponding component was not measured.

From Tables 1 and 2, it was found that Examples 1 to 5 using the electrolyte solution containing the ether not having a fluorine atom, the hydrofluoroether (HFE), and the saturated or unsaturated chain hydrofluorocarbon (HFC) had excellent cycle characteristic, did not cause phase separation, and had stability against changes in environmental temperature as compared with Comparative Examples which were different from the aforesaid Examples.

In the lithium secondary battery of the present invention, a high energy density, an excellent cycle characteristic, and a high stability against changes in environmental temperature are achieved, so that it has industrial applicability as a power storage device to be used for various uses.

What is claimed is:

1. A lithium secondary battery comprising:
a positive electrode;
a negative electrode not having a negative-electrode active material; and
an electrolyte solution,
wherein the electrolyte solution contains, as a solvent, an ether not having a fluorine atom, a hydrofluoroether, and a chain hydrofluorocarbon.

2. The lithium secondary battery according to claim 1,
wherein a molecular weight of the hydrofluorocarbon is 300 or more and 600 or less.

3. The lithium secondary battery according to claim 1,
wherein a boiling point of the electrolyte solution is 74° C. or higher.

4. The lithium secondary battery according to claim 1,
wherein a content of the hydrofluorocarbon is 5.0% by volume or more and 50% by volume or less with respect to a total amount of the hydrofluoroether and the hydrofluorocarbon.

5. The lithium secondary battery according to claim 1,
wherein the hydrofluoroether has a structure represented by Formula (1), 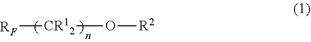
(in the formula, R_{F} is a fluorinated saturated or unsaturated monovalent hydrocarbon group, R¹ is a hydrogen atom or an alkyl group, R² is a saturated or unsaturated monovalent hydrocarbon group which may be fluorinated, and n represents an integer of 1 or more and 5 or less).

6. The lithium secondary battery according to claim 1,
wherein the hydrofluoroether has at least one of a structure represented by Formula (2) or a structure represented by Formula (3), 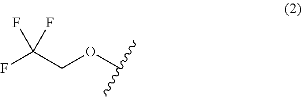 [SMILES: *OCC(F)(F)F]
(in the formula, a wavy line represents a bonding site in a monovalent group) 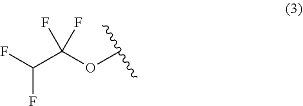 [SMILES: *OC(F)(F)C(F)F]
(in the formula, a wavy line represents a bonding site in a monovalent group).

7. The lithium secondary battery according to claim 1,
wherein, in the hydrofluorocarbon, a ratio (F/(F+H)) of a number (F) of fluorine atoms to a total number (F+H) of fluorine atoms and hydrogen atoms is 0.60 or more and 0.90 or less.

8. The lithium secondary battery according to claim 1,
wherein the electrolyte solution contains LiN(SO₂F)₂ as a lithium salt.

9. The lithium secondary battery according to claim 1,
wherein a total content of fluorinated solvents in the electrolyte solution is more than 50% by volume with respect to a total amount of solvent components.

10. The lithium secondary battery according to claim 1,
wherein a content of the ether not having a fluorine atom is 3.0% by volume or more and 50% by volume or less with respect to a total amount of solvent components in the electrolyte solution.
